(19) United States
(12) Patent Application Publication
(10) Pub. No.: US 2012/0278865 A1
(43) Pub. Date: Nov. 1, 2012

(54) METHOD, SYSTEM AND APPARATUS FOR IDENTIFICATION

(76) Inventor: Kip SAWDY, Jackson, WY (US)

(21) Appl. No.: 13/545,146

(22) Filed: Jul. 10, 2012

Related U.S. Application Data
(63) Continuation-in-part of application No. 12/902,889, filed on Oct. 12, 2010.
Application No. 12/902,889 is a continuation-in-part of application No. 12/576,690, filed on Oct. 9, 2009, now abandoned.

(51) Int. Cl. G06F 21/00

(52) U.S. Cl. 726/4

(57) ABSTRACT

One exemplary embodiment describes a method, system and apparatus for storing and providing data. A software application may be utilized on a smartphone or similar device to house data. The data may be accessed by a user to manipulate the data or view the data. The data may also be accessed by an authorized party, for example in the event of an emergency. The application and associated data may be accessed in a variety of manners and the data displayed or available may be adjusted by the user for security and appropriate usage.

### CROSS-REFERENCE APPLICATIONS

The present application is a Continuation-In-Part of U.S. patent application Ser. No. 12/902,889, filed Oct. 12, 2010, which is a continuation-in-part of U.S. patent application Ser. No. 12/576,690, filed on Oct. 9, 2009, the disclosures of which are incorporated by reference herein in their entireties.

### BACKGROUND

Identification systems are widely utilized in various nations and jurisdictions around the world. Typical identification systems revolve around a government issued identification card and the assignment of an identifier, such as a social security number. Examples of identification systems include driver's licenses and the information found thereon, social security cards and the related numbers and voter registration cards. Additionally, Homeland Security Presidential Directive 12 (HSPD-12) was enacted by President Bush to require extensive background checks and the submission of detailed information in order to acquire various government identification cards (such as “smart cards”) which may be used to access various government facilities and/or computers.

These identification systems, however, do not typically provide information beyond the carrier's name, address or physical characteristics, provided they have fulfilled any requirements to be admitted into such an identification system. Thus, in many situations, although the name of the person may become known by another party who is checking the identification of the person, important relevant information about the person may not be known. In some situations, such as where a person has been in an accident or is experiencing a medical emergency, they may be incapacitated or otherwise unable to provide any information to an emergency responder. Thus, in these situations, an emergency responder may not have access to important medical, physical or other information that could be of assistance or beneficial for the emergency responder to know.

### SUMMARY

One exemplary embodiment describes a method, system and apparatus for storing and providing data. A software application may be utilized on a smartphone or similar device to house data. The data may be accessed by a user to manipulate the data or view the data. The data may also be accessed by an authorized party, for example in the event of an emergency. The application and associated data may be accessed in a variety of manners and the data displayed or available may be adjusted by the user for security and appropriate usage.

### BRIEF DESCRIPTION OF THE FIGURES

Advantages of embodiments of the present invention will be apparent from the following detailed description of the exemplary embodiments thereof, which description should be considered in conjunction with the accompanying drawings in which:

FIG. 1 is an exemplary diagram showing an identification card.

FIG. 2 is an exemplary diagram showing a data and identification system.

FIG. 3 is an exemplary flowchart showing steps for collecting and disseminating data.

FIG. 4 is an exemplary diagram showing an identification system.

FIG. 5 is an exemplary diagram showing a smartphone and software application.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

Further, many of the embodiments described herein are described in terms of sequences of actions to be performed by, for example, elements of a computing device. It should be recognized by those skilled in the art that the various sequence of actions described herein can be performed by specific circuits (e.g., application specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in a number of different forms, all of which have been contemplated to be within the scope of the claimed subject matter. In addition, for each of the embodiments described herein, the corresponding form of any such embodiments may be described herein as, for example, “a computer configured to” perform the described action.

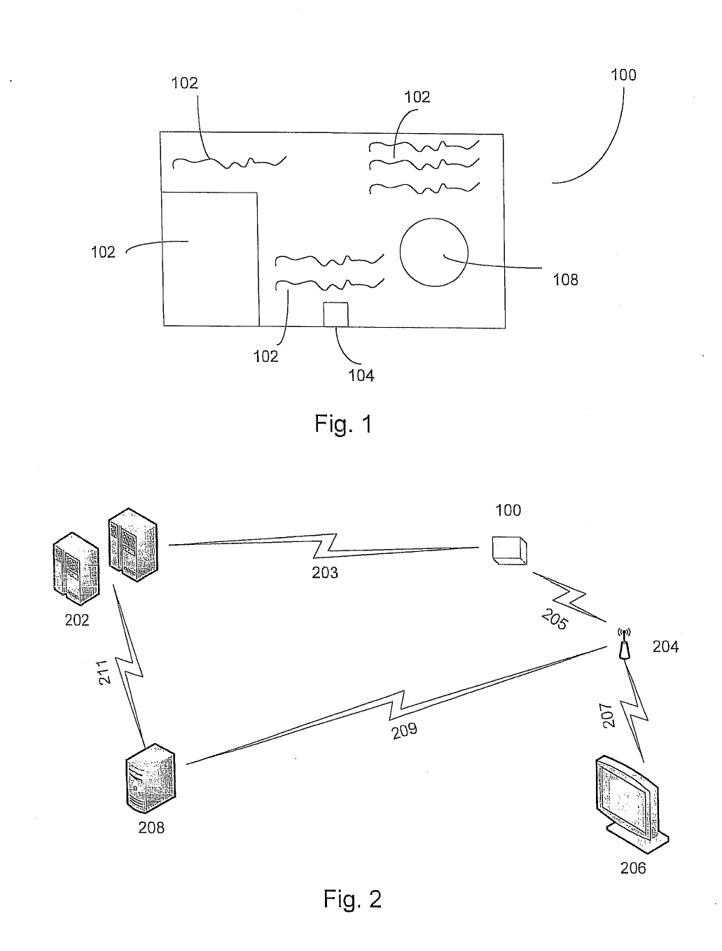

Generally referring to exemplary FIGS. 1-2, methods, systems and apparatuses for providing data may be described. The methods, systems and apparatuses can include one or more cards on which data regarding individuals may be stored as well as one or more remotely located databases on which data regarding a number of individuals can be stored. Further, in some exemplary embodiments, there may be a variety of ways in which data is collected and stored on the cards.

In one exemplary embodiment, an identification card may be utilized. The identification card 100 may be formed in any of a variety of manners, for example a card printed on plastic, paper that may be laminated or any other manner known in the art. The card 100 may include any of a variety of information, for example physical information about a user of the card, address information, identification information and medical information, as well as any other desired information, any of which may be printed on the card, for example in area 102. Additionally, information contained on the card can include medical conditions or any other information that might be relevant to a person or professional interacting with the user of the identification card, such as a police officer or emergency medical technician. Further, the card 100 can include any other desired data, rights or privileges that may be afforded to the holder. Examples of other data, rights or privileges include driver's license information, passport information, firearm permit information or any other desired data or information. Any indicia which may be printed on the card 100 may be printed in any area and may not be limited to area 102 as shown in exemplary FIG. 1.

The card 100 may also have one or more electronic devices or storage medium embedded into it, attached thereto or otherwise coupled or associated with it, such as electronic device 104. Alternatively, the card 100 may have one or more electronically readable media printed thereon, attached thereto or coupled or associated with it, such as a barcode or magnetic strip, which may be printed or disposed in any desired location. Examples of the electronic devices 104 that may be associated with the card 100 include a radio frequency identification (RFID) tag, a computer chip or a memory device. The electronic device 104 or electronically readable media may include any desired information. Examples of such information can include medical history, current medical conditions, identification information, physical information, family contact information, credit card information, banking information or any other information that may be desired to put on the card 100 or which may be useful to a police officer, emergency medical technician, search and rescue team or any other party providing care or service to the user of the card 100. Additionally, any other desired information, such as vehicle registration, vehicle insurance, health insurance, firearms permit information or any other data may further be included on the electronic device 104 or electronically readable media. In still further exemplary embodiments, a person's legal or citizenship information may also be included on the electronic device 104 or electronically readable media. Examples of this can include passport information, visa information, green card information, resident alien information or any other form of legal or citizenship data. Also, in some further examples, identification information beyond a person's name and social security number, and the like, may be included. Here, other identifying information, such as fingerprint information, dental record information and any other identifying information may be included on the card 100. Still further exemplary embodiments can include social media information which can be encoded or otherwise stored so as to provide only appropriate people access to social media information.

In still further exemplary embodiments, other indicia may be printed or disposed on the card 100. For example a picture 106 may be printed or otherwise disposed on the card 100 at any location. Similarly, a seal 108, such as a state or national seal, or a seal of any other jurisdiction, may further be printed or disposed on the card 100. Additionally, and as discussed herein, any other desired information may be disposed on the card 100 as desired.

In another exemplary embodiment, information on the card 100 may be scanned or otherwise read by any of a variety of authorized parties. Examples of authorized parties can include police officers, emergency medical technicians, doctors, coroners or any other party who may provide service, care or treatment to a user of the card 100. The card 100 may be read or scanned in any of a variety of manners, depending upon the storage medium or electronic device associated with the card or the electronically readable media. In some exemplary embodiments, a wireless, handheld scanner or any wired or hardwired scanners may be used to scan the card and/or any data found within the card 100. For example, if an RFID tag is associated with the card 100, the tag may be read with an RFID reader. Similarly, if a barcode is associated with the card 100, a barcode reader may be used to garner the information on the card 100. Any information that is received from the card 100 may then be transmitted back to a central location, such as a police station or a hospital, as desired or as may be beneficial in a situation. In still other exemplary embodiments, the card 100 may be coupled with a database that provides information to appropriate parties through a request for information. Such a request may be may through a computer and wired or wireless access to a database or by calling an appropriate phone number and entering an appropriate identifier found on the card 100. Data can then be provided to such parties either in an automatic fashion, may be provided by a physical operator with access to the information, or may be provided in any other manner known in the art. Such methods of acquiring information housed on the card 100 may be performed at any desired time and may be used in conjunction with or in lieu of the scanner or any other technology capable of reading data from the card 100.

In still other exemplary embodiments, data associated with the card 100 may be housed on any other desired device. For example, data may be housed on a portable storage device, such as a thumb drive or flash drive. In other exemplary embodiments, data may be housed on mobile or cellular phones, portable music players, such as Ipods®, disks, computer peripheral devices, data storage devices, electronic watches and the like. Such devices may be capable of communicating with other similar devices, scanners, readers, communication devices or other devices capable of transmitting or receiving data. Further, communication may be provided through any appropriate vehicular communication methods, such as, but not limited to radio transmissions, transmissions associated with devices similar to OnStar® and the like. Methods of data transmission include, but are not limited wired transmission, wireless transmission, terrestrial communication links, extraterrestrial (for example satellite) communication links or any other manner of transmitting data. Additionally, the data transmitted or received may be any form of data, for example text data, audio data, video data, and the like. Further, the data can be encoded or unencoded, as desired.

Further, any time a card 100 may be scanned, a report may be generated or an alert otherwise formed. This may allow for the prevention of abuse of the identification system, method and apparatus as well as prevent identity theft. For example, in some situations, authorized personnel may sign a form or otherwise show their identity and reasons for using a scanning device prior to being able to perform a scan. In other examples, a scanner may not be active until the reason for the scan is deemed appropriate or desired by an appropriate party. Additionally, if a scanner is used on a card 100, the cardholder may be provided with a report of when the scan was performed or why the scan was performed. This report may be generated electronically when the scan is made and may be transmitted to the cardholder in any desired fashion, for example email, text message, phone call, mail, fax or any other known manner. The report may further include, or the cardholder may further be given access to any of a variety of information regarding the scanning of his or her card 100, including the party who performed the scan, the entity for whom the party who performed the scan is employed, contact information for questions regarding the scan and any other desired information. Alternatively, if a scan is made under certain conditions, for example after a card holder's death by a coroner, for example to determine an identity, notification may be sent to the card holder's family members or next of kin.

In yet a further exemplary embodiment, one or more databases may be used to contain the information on the cards 100. In different examples, a different number of databases may be utilized or different data centers having different numbers of databases may be utilized. For example, each state may have one or more centrally located databases that may contain the data associated with the cards possessed by citizens of that state. Similarly, other exemplary embodiments can have centralized databases provided on a city, county or national level, or any other division of data storage as desired.

As shown in exemplary FIG. 2, any number of databases may communicate with one or more cards. In this example, databases 202 may store any desired information, as discussed previously. Databases 202 may communicate in any desired manner with a card 100, such as through a wired or wireless connection 203 to allow for any updating of a card 100 or to report any scanning of card 100. Card 100 may further be scanned at any time, for example using scanner 204 to wirelessly read any data on card 100 through connection 205. Scanner 204 may then have any desired type of display or may be capable of wired or wirelessly transmitting, for example through connected 207 any data collected from card 100 to a display 206. Further, after a scan is performed by scanner 204, a communication may be sent, for example through communication link 209 to a remote server 208 that can provide an indication to the cardholder of card 100 that the card 100 has been scanned, as discussed herein. Further, any data that may be sent or stored on remote server 208 may also be shared with databases 202, for example through communication link 211.

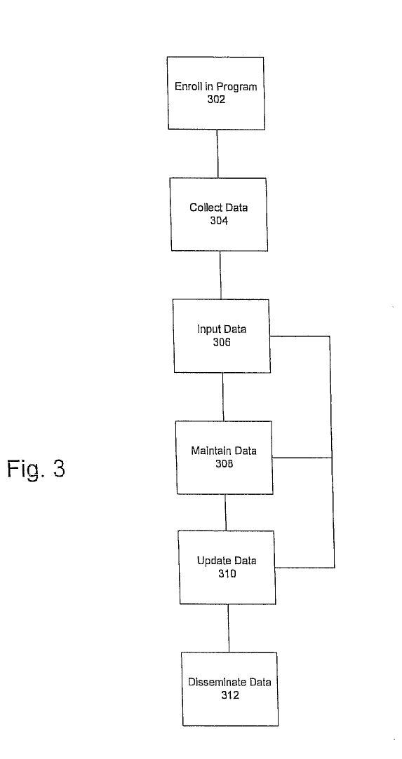

In still a further exemplary embodiment, and as shown in the exemplary flowchart in FIG. 3, a jurisdiction may have its residents, members or citizens enroll in a program 302 that provides information to be stored on an identification card or may have its residents, members or citizens submit information to a governing body or data administrator. In such exemplary embodiments there may be one or more agencies, administrations or other personnel that collect data from individuals 304, input data into one or more databases 306, maintain the data in the one or more databases 308, update the data in the one or more databases 310 and disseminate data from the one or more databases 312. As discussed previously, individuals may provide one or more types of data to a card administering body. The data may be submitted in any of a variety of manners, for example through an electronic data submission system (including an online interface) or through any other manner of providing or submitting data. Additionally, as discussed with respect to other examples, the information may be communicated back and forth amongst several sources, for example from a card to a scanner, from a scanner to a display, from a scanner to a server, from a server to a database and from a server to an enrolled member of the program.

The data submitted by the individuals in step 304 may be any of a variety of types of information. Examples of data submitted may include personal identification information, such as a full name, address, social security number and the like. Additionally, physical information such as height, weight, hair color and eye color may also be submitted. Other information can include medical information, such as ongoing medical conditions or medical needs, DNA information, blood type, medical history, legal or criminal history, next of kin information or any other desired information. Other information can include information that can be utilized with medical devices. For example, if an individual utilizes an insulin pump, such information may be included in the data of step 304 and such data can be provided to medical professionals or may be communicated directly with a medical device that may be able to administer or monitor treatment or supplying of medication, such as insulin. In a similar exemplary embodiment, fingerprint or DNA information or any other identifying information could be submitted by an individual and could be read by an appropriate identification-determining device.

In another exemplary embodiment, a jurisdiction may incentivize citizens or members of the jurisdiction to carry the card on them or with them or to enroll in the program, as in step 302. For example, while an individual is in a jurisdiction, they may have the card on their person or with their belongings. Alternatively, if a person is not carrying a card on their body or with their person, he or she may be penalized. A person may be penalized in any desired manner, for example a warning, citation or fine.

In still other exemplary embodiments, the card may provide a source of revenue for an administering body. In this example, when an individual registers or otherwise provides information to an administering body, a fee may or may not be charged by the administering body in conjunction with an enrollment in step 302, as desired. The fee may be any desired fee and may be used for any desired purpose. For example, the fee may be used to provide the card to the individuals. Additionally, the fee may be used to help maintain, update and backup the data. Further, the fee may be used to pay personnel associated with the administering body or may be disseminated or shared with any other entity or agency, including government entities and agencies. For example, the fee may be used to repay any form of debt (e.g. national debt), allocated to pay for other projects (e.g. national or state repair or relief projects) or used in any other desired manner. Additionally, any funds used or allocated as a result of the present method, system and apparatus may be made either publicly available or available to people or personnel who have or use the cards or the identification system. This information may be made available in any manner, for example through the publishing on a website.

In still further exemplary embodiments, upon fulfilling any other requirements or suggestions prior to receiving an identification card, a potential card holder or user may agree to any desired terms or conditions. Terms or conditions may include a waiver of the ability to sue a first responder, emergency medical technician or the like.

In other exemplary embodiments, the systems, methods and apparatuses described herein may be used on any scale. Thus, while an implementation may be utilized on a local scale, it may also be utilized on a national or international scale. For example, such systems, methods and apparatuses may be utilized throughout the United States. Similarly, these systems, methods and apparatuses could also be used in another country, such as China. The systems, methods and apparatuses may further be able to communicate across international borders, thus allowing for data scans, information updates or any other desired use of the methods, systems and apparatuses to occur anywhere where any relevant tools or equipment are available. Similarly, if a scan occurs in any nation, desired contacts or messages may be dispatched to any other desired nation or locality, as may be dictated by the conditions of the scan or the situation.

In a different exemplary embodiment, the embodiments described herein may be used in conjunction with another national identification system, such as the social security number system. Here, upon a scan of an identification card after a card holder has died, for example by a coroner, a notification may be sent that the card holder is dead and that the card holder's social security number is no longer active. This may assist, for example, in helping to prevent identity theft and some governmental fraud through the use of a deceased person's social security number. Additionally, in this exemplary embodiment, the social security administration may be immediately notified of a person's death and may take any further precautions desired. For example, they may choose to deactivate a social security number for a period of years before reissuing it to a new person.

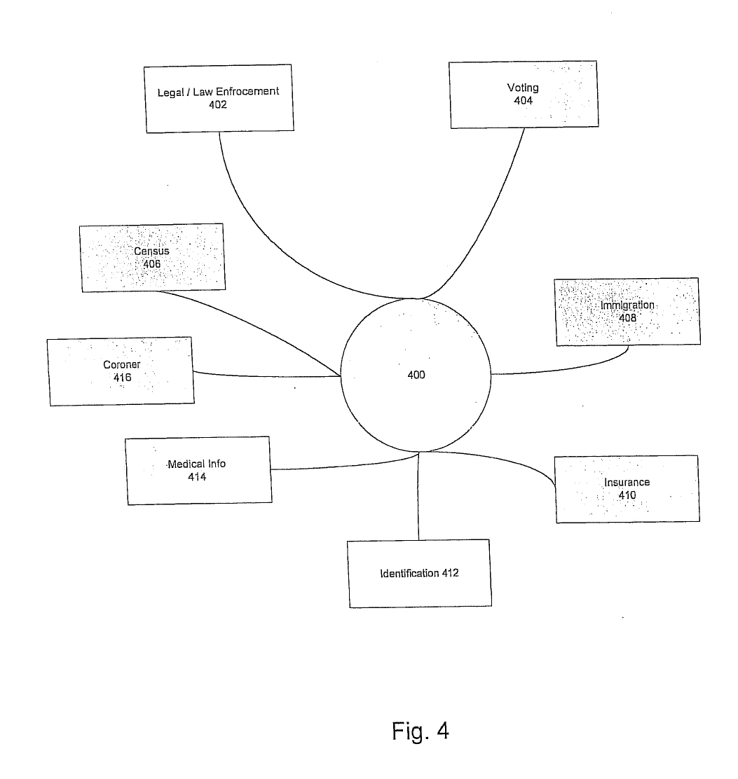

In another exemplary embodiment, and as shown in FIG. 4, an identification system and apparatus may be used to perform any of a variety of functions. Further, the functions shown in exemplary FIG. 4 may be performed simultaneously or in concert with one another. Additionally, any number of functions may be employed or utilized by with the system 400 and the number of functions employed by a system 400 in one embodiment may be different from the number of functions that may be employed or utilized in any other embodiment. Examples of uses include legal and law-related uses 402, which can include criminal history as well as contact information for the purposes of serving warrants, locating individuals and monitoring individuals. Additionally, the system 400 can be used for voting 404 or voter registration services, as well as identifying people at polling places. The system 400 may also be used for census 406 information so as to provide accurate and up-to-date information about a populous. The system 400 can also be used for immigration 408 purposes. For immigration 408 uses, the system can contain nationality information, immigration status, the legality of presence in a nationality, visa status or any other desired immigration information. The system 400 can also be used for insurance 410 information, which can include vehicle and medical insurance, as well as any other type of insurance. Another use of system 400 can include any type of identification 412 information, such as driver's license information, gun permit, concealed carry permit, federal firearms license or any other type of permit that may include identification information there on. Identification information 412 may also include any other type of identification materials as desired, such as fingerprint data, dental record data, eye scan, retinal scan or any identification data associated with eyes, DNA data or any other potentially identifying data that may be associated with an individual. In still further exemplary embodiments, identification information 412 can also include body scan data and Integrated, Automated Fingerprint Identification System (IAFIS) data. Additionally, identification 412 can be used by a coroner 416 or medical examiner to identify a body as well as to provide contact information for next of kin, in addition to providing family or any other appropriate personnel with desired burial information, for example if the individual desires to be cremated or buried intact as well as if the individual has secured a location or property for a burial. Further, the identification 412 may be used by a coroner 416, medical examiner or other party to notify any relevant agencies, such as a government social security agency, that an individual has died. In some further exemplary embodiments, a notification or instructions may be provided through system 400 that a person has died and which may be connected to any other systems, for example to stop any automated payments, such as social security payments to the deceased or to disallow the deceased individual or anyone claiming to be the deceased individual from voting in any further elections. System 400 can still further be used to maintain and access medical information 414, which can include medical history information, medical conditions, prescription information, electronic medical record information or any other type of medical data desired. Still other uses of system 400 that pertain to housing information about any number of individuals can be visualized and may be implemented and utilized as desired.

In still other exemplary embodiments, system 400 may be capable of acting as a credit, debit or banking system. For example, system 400 may include information pertaining to one or more credit or debit cards, one or more bank accounts or any other manner that a user of system 400 may be able to verify funds and/or pay for goods or services. Additionally, as system 400 may be used in any desired location, a currency conversion may be built in to any function of system 400 to allow a user to pay for goods or services in any desired location. Further, system 400 may include its own form of currency or a world currency which may be accepted in any location.

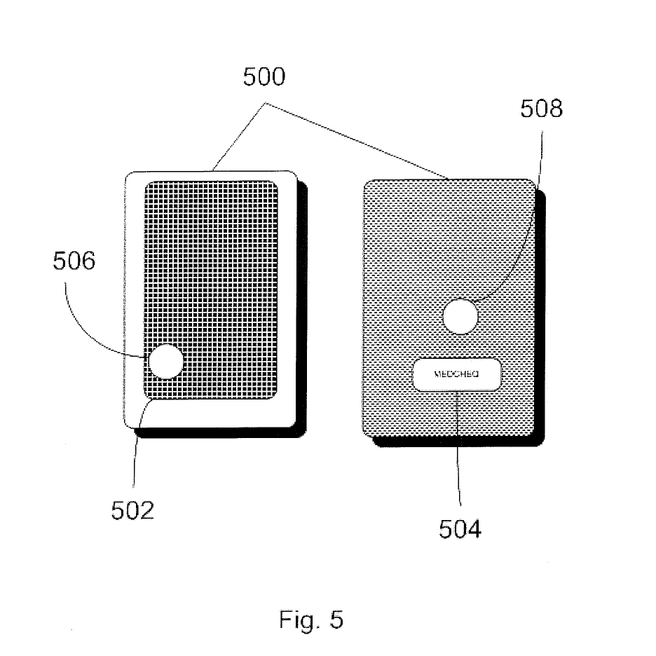

In still another exemplary embodiment, and referring now to FIG. 5, an application or software utilized to store and provide the above-described information and data could be found on a smartphone, personal digital assistant or similar device, such as a computer. For example a smartphone 500, which may be any type of smartphone, may be commonly carried or used by any number of individuals. The smartphone 500 may be capable of storing and running any sort of programs, data and the like. For example smartphone 500 may be capable of downloading, storing and running application 502. Application 502 may be such that it is capable of housing and displaying, to an appropriate, desired or authorized party, any information described in the above exemplary embodiments. For example driver's license information may be housed and displayed, medical history or condition information may be housed and displayed, voter information or any other desired information or data. Other exemplary types of data can include, but are not limited to blood type, donor information, medication or prescription information, pharmaceutical information used to verify prescriptions, doctor or physician information, physical description of self or family members, family medical needs and information with picture for ID, software and databases for prescription accountability for drug manufacturers, pharmacies, hospitals, doctors, citizens, citizenship or immigrant status, voting information and qualifications, last will and testament information, living will information, hunting licenses, insurance information in all areas, and the like. Further, similar to some previously described embodiments, bank or credit card information may also be associated with the application 502. As in the above exemplary embodiments, such data may be accessed by an appropriate party upon entry of an appropriate authorization code, by connecting the smartphone to an authorized reading device or any other desired manner of providing authenticated access. In examples where an outside device or reader, such as a dedicated reader, mobile computing device or other smartphone, is connected to the smart phone 500 in order to access data housed thereon, the connection can be made in a wired or wireless fashion. For example a cable could be coupled to a port of the outside device and a port on the smart phone 500. Alternatively, the outside device could query the smartphone 500 using one of a plurality of wireless communication protocols, which may be secure. Such protocols can include, but are not limited to Bluetooth, near field communication, radio frequency identification, cloud networking, digital, hologram technology, space or any out of orbit technology, networked communication and the like.

In still further exemplary embodiments, when a user has a smartphone 500 with the application 502 running thereon, some form of indicia may be provided that allows outside parties to recognize that the application 502 and its associated information may be found thereon. For example, in the case of a car accident, a first responder may see an injured person and may find a smartphone 500 in his or her pocket. The smartphone 500 may have sticker 504 or any other indicia mounted thereon, for example on a back portion of smartphone 500. This can provide notice to the first responder (or any other party) that the smartphone 500 includes application 502, which may then be accessed in an appropriate manner so as to provide identification or other information so as to assist in medical treatment. In other exemplary embodiments, a sticker or other indicia could be provided on an automobile, a piece of clothing or jewelry or any other desired format.

In further exemplary embodiments, application 502 may be such that it can be tailored to the desires of a user. For example the user could enter only desired information into application 502, such as, but not limited to, medical history and identification data. The information may be edited as desired by a user. Additionally, the application 502 could allow for interfacing with another device or computer so as to rapidly transfer data in any desired fashion. For example if a user had medical history stored on a computer or if a medical provider gave access to electronic medical records, they could be rapidly transferred to the application 502.

In a further exemplary embodiment, application 502 may utilize a button on a user interface of the smartphone 500, within the application 502 (for example button 506) or otherwise disposed on the smartphone (for example button 508). Such a button can allow for rapid access to the application 502 or some specific information associated with the application 502. For example, if a first responder came across the victim of an accident, the first responder could press button 508 (for example) to quickly and easily access medical information that may be relevant to the victim. This can include medical information as well as picture or photograph data that can be used to assist in verifying an identity of oneself or family.

In still further exemplary embodiments, the information or data associated with application 502 may be partitioned or divided in any desired fashion. For example, a user could house any and all information that they wish to have securely stored in their smartphone 500 using application 502. This could include passport information, credit card information, social security information or any other information that they may desire to store therein, in addition to identification information, medical treatment or medical history information, and the like. However, it may not be desirable to allow any outside parties access to all of the desired information. Therefore, a user can designate any information in application 502 that they may want to be accessed by outside parties, for example first responders in an accident or emergency situation. Thus a first responder could access medical or other relevant data, but information irrelevant to an emergency, such as credit card information, may not be displayed or otherwise accessible by such parties.

In a further exemplary embodiment, button 506 or button 508, for example, may be utilized to or associated with data or information that is designated by the user of smartphone 500 and application 502. Thus, in the above exemplary embodiment, if a first responder were to press button 506 or 508, information that may be beneficial to view in an emergency may be made available while other potentially sensitive or irrelevant information may be hidden or be otherwise inaccessible.

In still another exemplary embodiment, application 502 may be used to verify a person's identity so that they can vote or perform another operation that may rely on a positive identification of the person. For example, application 502 may be associated with a phone number. This can allow individuals to securely provide identification. Additionally, as desired, other forms of information may be available to confirm an identity, such as social security number or biometric information. Thus, a person could open application 502 and either have their identification verified automatically or provide further information, such as a social security number or biometric information, such as a scanned fingerprint using an associated device. Application 502 may then be communicatively coupled to an outside network and a state or federal voting application or software that allows the person associated with application 502 to safely and securely vote in an election from a remote location, for example, away from a brick and mortar voting center or polling place. Application 502 may further be such that it may only be associated with a single individual and that multiple instances of the application by the same individual can be prevented so as to avoid any voter fraud. Additionally, it may be noted that application 502 may be utilized on any computing platform, such as smart phones, computers and the like.

Additionally, in another example, application 502 may be used to securely hold any desired medical information, including prescription information. For instance, patient may visit a doctor for treatment of an ailment and receive a prescription to treat the ailment. Instead of a typical hand-written prescription, the doctor, or other authorized personnel, may electronically transmit the prescription to the device 500, utilizing application 502 to assist in securely storing and accessing the prescription data. The electronic transmission may be through any form desired, such as, but not limited to, SMS, MMS, email, near field communication and the like. The user of device 500 may then be able to access prescription data. Additionally the user may present this data to a pharmacist in order to have their prescription filled. When the prescription is filled, the pharmacist may be able to transmit information that indicates that the prescription in filled to prevent errors or fraud. Additionally, application 50 may allow for the storage of historical prescription or other medical data to show how often a person is filling their prescription or if there is some evidence of abuse. This information may also be made available or accessible to other appropriate parties, such as first responders and medical care providers in order to determine if a person with device 500 running application 502 is using prescribed medication.

Additionally, as the application 502 may be able to show prescription and medical history information to appropriate parties, prescription fraud or theft may be prevented. Additionally, it may assist in preventing or decreasing the abuse of prescription drugs. Further, if a user of application 502 is utilizing it to obtain prescription medicine, that person may be prevented from visiting multiple doctors in order to obtain further prescriptions for drugs as the other parties could have access to the prior prescriptions and, therefore, see that there was some form of fraud or abuse. Similar to other exemplary embodiments, application 502 may be provided in any of a variety of manners, including purchasing of a license, subscription payments, or any other desired manner. Additionally, the application 502 may further be used by centralized retailers or distributors to manage and control inventory, as well as take or receive orders.

In still another exemplary embodiment, application 502 may allow for dynamic language functionality on the device. For example, application 502 may have settings that allow any language to be used or displayed. However, if any geolocation or global positioning capabilities of device 500 detect it is in a location where a different language is spoken than that of settings of application 502, it may provide alert messages or access messages in the native language of the area. Thus, if English is used as a primary language of the device 500 and a holder of device 500 travels to Germany, in the event of an accident where a first responder may check the phone, the user's contact information or relevant information for the first responder may be provided in German as well as English. This could further be utilized in any location and for any desired languages.

The foregoing description and accompanying drawings illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A system for housing and displaying data, comprising:
a mobile computing device with a software application running thereon, the software application housing a plurality of data related to a user;
the plurality of data accessible by at least one of a user on the mobile computing device, an authorized party using the mobile computing device and an outside device coupled to the mobile computing device.

2. The system for housing and displaying data of claim 1, wherein the mobile computing device is a smart phone.

3. The system for housing and displaying data of claim 1, further comprising a button associated with the software application that provides access to data.

4. The system for housing and displaying data of claim 3, wherein the button is disposed within the software application.

5. The system for housing and displaying data of claim 3, wherein the button is disposed on the mobile computing device.

6. The system for housing and displaying data of claim 1, wherein the outside device is one of a dedicated reader and a second smartphone.

7. The system for housing and displaying data of claim 1, wherein the outside device is coupled to the smartphone in at least one of a wired and wireless manner.
